(19) United States
(12) Patent Application Publication
(10) Pub. No.: US 2015/0011165 A1
(43) Pub. Date: Jan. 8, 2015

(54) PORTABLE INFORMATION TERMINAL DEVICE HOLDER AND CONTROLLER FOR PORTABLE INFORMATION TERMINAL DEVICE

(71) Applicant: SHINTEC COMPANY LIMITED, Kitakyushu, Fukuoka (JP)

(72) Inventor: Nin Shinkawa, Kitakyushu (JP)

(21) Appl. No.: 14/368,800

(22) PCT Filed: Dec. 19, 2012
(86) PCT No.: PCT/JP2012/082925

§ 371 Date: Jun. 26, 2014

(30) Foreign Application Priority Data
Dec. 26, 2011 (JP) 2011-284035

(51) Int. Cl. H04B 1/38; H04B 7/26

(52) U.S. Cl. CPC H04B 1/3888; H04B 7/26
USPC 455/41.2; 455/90.3

(57) ABSTRACT

The Invention is a supporting holder for portable information terminal device and controller for installation of information terminal device without the limitation of size, which is compact and easily portable. The holder of this invention has the Holder (10) for said device that has short range wireless communication function and it is featured with a pair of arms (11 & 12) with the supporting axis (18) as the fulcrum to hold and remove the said device by clamping. The spacing setting of the front end of said holder is adjustable. Installation Portion is consisted of the Controller (30) to install the said device, in freely mounting and dismounting manner. A pair of arms (11 & 12) can be locked in any angles. Also, the controller (30) is comprised of mounting portion to install and remove the holder (10) freely and operation portion to operate the portable information terminal and short range wireless communication portion have communication by the device.

### TECHNICAL FIELD

The invention is a holder to hold the device with wireless communication function and the controller to mount the holder for the said device.

### BACKGROUND ART

Through connecting the device, such as mobile phone and operating the buttons/knobs, it is not necessary to press the keys of the device and still can play the games, such as the invention of information terminal input assisting device as disclosed in Patent Literature 1, which has a base of the terminal installation portion for installation of the device at the center, the connector for connecting the device, control portion that has multiple control buttons installed at both sides of installation portion; the operation portion consisted of multiple operating buttons and supporting arms that support the device.

However, the input assisting device for the use of information terminal as stated in Patent Literature 1 requires the firm contact between the connecting terminal of communication port with the connecting terminal of connector of information terminal input assisting device, so, subject to the state of installation of information terminal, poor contact could be occurred between the terminals and caused the operation of information terminal device out of order.

Therefore, in Patent Literature 2, there is an invention of external operating device disclosed which has: installation portion allowing to install and remove the device freely; operation portion to operate communication terminal device and short range wireless communication portion to have communication by the device with Bluetooth (trademark) or similar short range wireless communication design and control portion to control the operation information operated by operation portion transmitted through short range wireless communication portion to the communication terminal device.

According to Patent Literature 2, installing communication terminal device to the external operation device installation portion, the external operation device can have short range wireless communication with the device and would not have the communication blocked due to poor contact of connection terminal as was seen in ordinary devices and it allows operation of communication terminal device from external operation device.

### CITATION LIST

### Patent Literature

Patent Literature 1—Japanese Patent Application Publication Gazette 2002-123353

Patent Literature 2—Japanese Patent Application Publication Gazette 2011-176602

### SUMMARY OF INVENTION

### Technical Problem

However, the external operation device as stated in Patent Literature 2, the installation portion for accommodating communication terminal device is located at the central part of the shell and formed a cavity of depth and length roughly same as the external dimensions of communication terminal device, and there is the problem that the size of communication terminal device is restricted and the external operation device needs to be enlarged in dimensions.

This invention was completed against the above and aimed to provide a supporting device and a portable information terminal controller to install the holder of the device that would not impose restriction to the size of said device, which is compact and easy to carry.

### Solution to Problem

To achieve the above, the first technical feature of the invention is a holder of portable information terminal device which holds portable information terminal device with short range wireless communication function.

The characteristics are: a pair of supporting arms with the front end holding a portable information terminal device; and a mounting portion for mounting a controller in a manner that can mount and remove freely to operate the portable information terminal device.

A pair of said supporting arms with the spacing of the front ends set to be adjustable.

In the first invention, the front ends of a pair of supporting arms with the front ends spacing set to be adjustable for holding portable information terminal device, which gives no restriction on the size of mountable portable information terminal device. On the other hand, if the spacing of the front ends of said pair supporting arm to its minimum, it will become dense, so when it is not in use, it is easy to collapse to most compact size.

Also, in the supporting device of portable information terminal device of the first invention, the supporting arms is using supporting shaft as fulcrum and form a mechanism for closing and opening.

At the supporting shaft axially supported by the base ends of said pair supporting arm, install cylindrical element around it.

The cylindrical element connects to the base end of one supporting arm and is rotating together with the said supporting arm around the supporting shaft and it can be moved along the supporting shaft.

By engaging the cylindrical elements formed 1^{st} gear portion and the 2^{nd} gear portion formed by another supporting arm base end, they lock the closing and open angles of a pair of the arms and with the disengagement of the 1^{st} and 2^{nd} geared portions, the locking is released.

In the construction, a pair of supporting arm use supporting shaft as fulcrum to form a closing and opening mechanism; cylindrical elements installed around the supporting shaft connect to the base end of a supporting arm and are rotating around supporting shaft with the supporting arm. Cylindrical elements can move along supporting shaft, and by moving the cylindrical elements toward one direction of supporting shaft, and with the engagement of 1^{st} geared portion formed with cylindrical elements and the 2^{nd} geared portion formed at base end of the other supporting arm, they limit the rotation freedom of a supporting arm around supporting shaft. On the other hand, with cylindrical elements moving to another direction of supporting shaft, the disengagement of 1^{st} geared portion formed with the cylindrical element and 2^{nd} geared portion formed with the base end of another supporting arm, it allows one of the supporting arm to rotate around supporting shaft.

Also, the supporting device of portable information terminal device of 1^{st} invention, it can be set that said supporting arm is set to a mechanism that the other said supporting arm can be slide to it, and with the 3^{rd} geared portion extended in the sliding direction formed with the other said supporting arm engaging with the 4^{th} geared portion set in movable manner with one of the supporting arm to lock the sliding of the other said supporting arm to the supporting arm, and with disengagement of the 3^{rd} geared portion and 4^{th} geared portion, the lock is released.

In the construction, with sliding of the other supporting arm to the supporting arm, it adjusts the spacing of the front ends of the pair of supporting arm. With the 4^{th} geared portion set with one supporting arm moving to one direction engaging the 3^{rd} geared portion formed with another supporting arm prevents the sliding of the other supporting arm to the supporting arm. On the other hand, With the 4^{th} geared portion moving to the other direction that disengaged the 3^{rd} and the 4^{th} geared portions, allowing the other supporting arm to slide to the supporting arm.

Further, the 2^{nd} technical feature of the invention in this case is a portable information terminal device controller operating portable information terminal device with short range wireless communication function.

The characteristics are: the mounting portion can freely install and remove the holder made under the 1^{st} invention techniques; operation portion is for operating the device and, short range wireless communication portion is for communicating with the device.

In the 1^{st}˜2^{nd} Invention Technical features, with the installation portion set with the holder of portable information terminal device and the mounting portion set with Controller of portable information terminal device, portable information terminal device holder is mounted to the controller of portable information terminal device in freely mounting and removing manner, so when it is moving, the size is not sizable and is easy to carry.

Also, the installation portion of the holder of portable information terminal device in the 1^{st} features of the invention and the mounting portion of controller of portable information terminal device in the 2^{nd} features of the invention can be designed to be in slide engagement.

In such construction, by setting the installation portion of holder of portable information terminal device and the mounting portion of controller for portable information terminal device into sliding engagement, the engagement of the said holder with said controller, as well as the disengagement become easier. The forms of sliding engagement include setting the installation portion to be strip (or groove) and the Mounting Portion of said Controller to be groove (or strip) matching with the strip (groove) of the installation portion.

In this invention, front ends of a pair of supporting arm where the spacing of the front ends is adjustable for holding portable information terminal device, so there is no limitation on the size of portable information terminal devices to be installed. Also, it can have the portable information terminal device holder installed and removed freely to the controller of the portable information terminal device, so it is compact and easy to carry.

### BRIEF DESCRIPTION OF DRAWINGS

FIG. 1 is 3-D view of holder of portable information terminal device of the 1^{st} embodiment of the invention.

FIG. 2 is disassembled 3-D view of the holder of portable information terminal device.

FIG. 3 is 3-D view of controller of portable information terminal device of one of the embodiments of the invention.

FIG. 4 is 3-D view of the controller of portable information terminal device.

FIG. 5 is a block diagram of the controller of portable information terminal device.

FIG. 6 is 3-D view of the device controller for installing the holder of portable information terminal device.

FIG. 7 is 3-D view of the device controller for installing the holder of portable information terminal device in use.

FIG. 8 is a side View of another example of use of the device holder.

FIG. 9 is 3-D view of portable information terminal device holder of the 2^{nd} embodiment of the present invention.

FIG. 10 is 3-D view of holder of the device.

FIG. 11 is Partial Sectional View of A-A arrow direction of FIG. 10.

FIG. 12 is 3-D view of the device controller for installing the holder of the device holder.

### DETAILED DESCRIPTION OF THE PREFERRED EMBODIMENTS

Next, please take reference of the figures appended which explains the practical forms and shape of the invention.

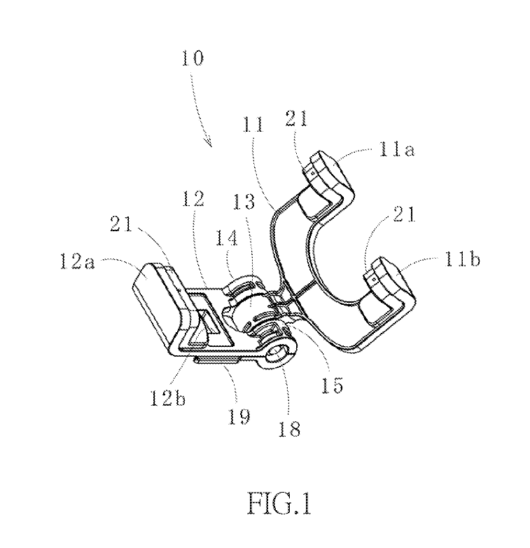

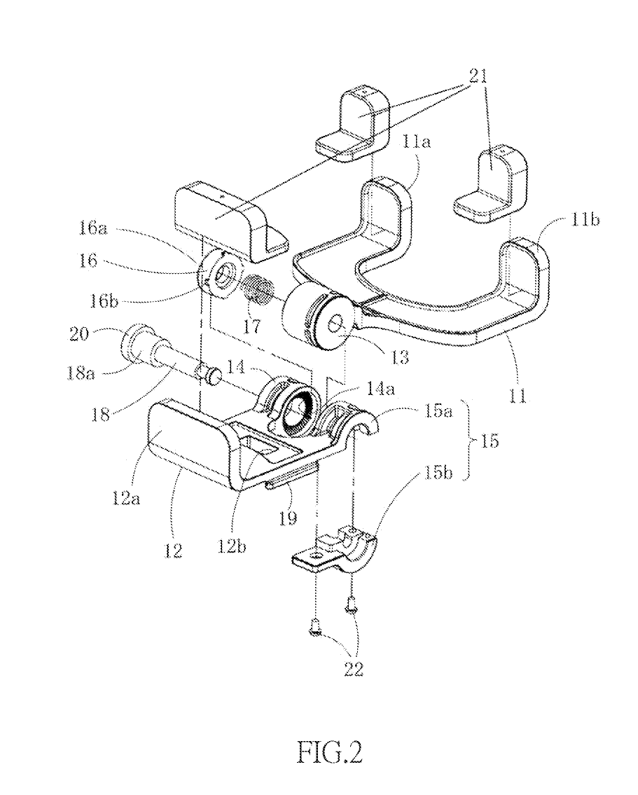

The implementation forms of the device holder (10) of the present invention are shown with 3-D drawing in FIG. 1 and the exploded 3-D diagram is shown in FIG. 2.

The device holder (10) is fixed to the clamp of the device that has short range wireless communication function, and branch shaft (18) is used as fulcrum to open and close and it has a pair of branch arms to clamp the device. The upper branch arm (11) and lower branch arm (12) are used to install, in the manner of freely installation and removal the installation portion (19) formed with the device controller (30) that is capable to operate the device.

Further, the device with the short range wireless communication function can accommodate Bluetooth (trademark) mobile phone or PDS (Personal Digital Assistant) and intelligent mobile phone set.

Upper branch arm (11) is built with roughly U-shape plate mass. The split two front ends is the holding portion (11a & 11b) for holding the device, and in side view, it is curved in L-shape. Also, the base end set at the center of the upper side supporting arm 11 is the cylindrical shaft supporting part of axial supporting Branch Shaft 18.

On the other hand, the lower branch arm (12) is built with plate mass in roughly rectangular shape. The front end part is the clamping part (12a) for clamping the device and in side-view it is curved and in L-shape. Also, base end part of the lower branch arm 12 is split to be the cylindrical shaft supports (14 and 15) of axial supporting shaft (18). But the shaft supporting part 15, for reason of manufacturing, and is consisted of two semi-cylinders (15a & 15b) and is a mechanism combined with Key (22). The direction of supporting shaft (18) is mutually perpendicular with the assumed plane symmetrically split by Lower Supporting Arm (12)

At the clamping portion 11a & 11 b of upper branch arm and the clamping portion 12a of Lower branch arm that contact the device are adhered with elastomer (21) made of rubber or similar.

Between shaft branch 14 and 14 of lower branch arm insert shaft branch 13 that is for installing upper branch arm (11) and branch shaft 18 is inserted through shaft branch portion 13, 14 and 15.

Install cylindrical element 16 that can slide along branch shaft 18 around branch shaft 18. One end of the cylindrical element 16 inserts into the shaft branch portion 13 of upper branch arm 11 which formed a cave (Figure illustration omitted.) Between the bottom of the cave and the other end of cylindrical element 16 insert and install coil spring 17, and the cylindrical element 16 press to the direction of shaft branch portion 14 of lower branch arm 12.

All around the outer peripheral surface of a side of end of cylindrical element (16) form the 1^{st} geared portion 16a and at outer peripheral surface of one side of the other end of cylindrical element (16) for protruded portion (16b) from the outer peripheral surface. On the other hand, at the inner peripheral surface of shaft branch portion (14) of lower branch arm (12) form 2^{nd} geared portion (14a) and to engage with the 1^{st} geared portion (16a) which if formed on the outer peripheral surface of cylindrical element 16; the cavity formed with shaft branch portion (13) of upper branch arm (11) in the direction of Branch Shaft (18) and formed a groove for insertion of the protruded portion (16b) formed on the outer peripheral surface of cylindrical element 16.

At one end of branch shaft 18 (at the side of branch shaft portion (14) where the inner peripheral surface formed 2^{nd} geared portion (14a) for a portion 18a with the diameter expanded than other part, and a press button (20) created at the diameter expanded portion (18a).

If the press button (20) is pressed, the diameter expanded portion 18a formed with branch shaft (18) will be pressurizing cylindrical element (16) and the cylindrical element (16) will be moving to one side of shaft branch portion (13) of upper branch arm (11). Through such mechanical connection, the 1^{st} geared portion formed with the outer peripheral surface of cylindrical element 16 and the 2^{nd} geared portion (14a) formed with the inner peripheral surface of shaft branch portion of the lower branchy arm (12) will be disengaged. When press button 20 is pressed, if the upper branch arm (11) rotating around branch shaft (18) and connect the cylindrical element (16) of shaft branch (13) of upper branch arm (11), it will rotate with upper branch arm 11. This is to say, acting on lower branch arm (12) can allow upper branch arm (11) to rotate freely (open/close) and further adjust the spacing of the front ends of the lower and upper branch arms (12 and 11).

If the press button is released, the elasticity of coil spring (17) installed to the shaft branch (13) of upper branch arm (11) the cylindrical element (16) will be moving to the side of shaft branch (14) of lower branch arm (12) the 1^{st} geared portion (16a) formed on the peripheral surface of cylindrical element (16) and the 2^{nd} geared portion (14a) formed on the inner peripheral surface of shaft branch (14) of lower branch arm (12) will be engaged. By this, cylindrical element (16) and the shaft branch (13) of upper branch arm 11 connecting cylindrical 16 via protruded (16b) will be kept from rotating around branch shaft i.e. locked the open/close angle between upper branch arm 11 and lower branch arm (12). By pressing again press button (20) it allows 1^{st} geared portion (16a) to be disengaged with 2^{nd} geared portion (14a) and release the locking.

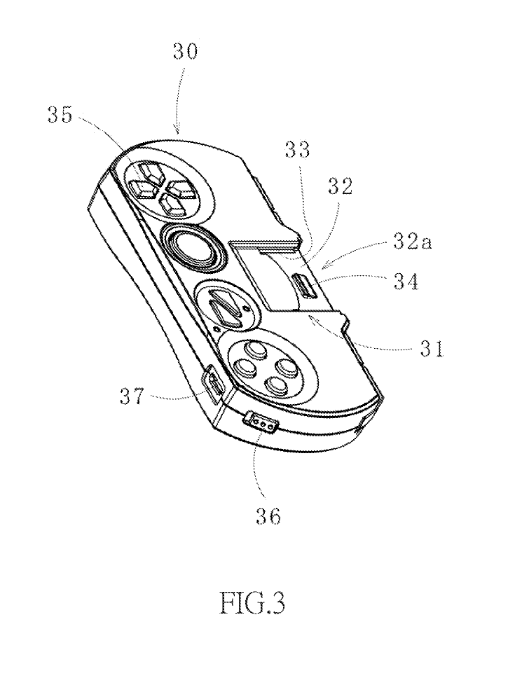

The installation portion (19) for installing to the controller of the device (30) in freely installing and removing manner is formed with protrude strip at the two edges of the longitudinal direction of lower branch arm (12). Also, at the opening (12b) formed at the middle part of lower branch arm (12) is inserted with the locking button (34) set to the portable information terminal controller (30). (Ref. FIG. 3)

FIG. 3 is the device controller (30) that receives the device holder (10).

Portable information terminal controller (30) is in long bar shape laterally. At the long edge of the surface of portable information terminal controller is installed with multiple operation key (35) to be used for operating portable information terminal controller and at the central part of the other long side of surface of portable information terminal controller (30) is set with mounting portion (31) for installing or removing portable information terminal holder (10) freely.

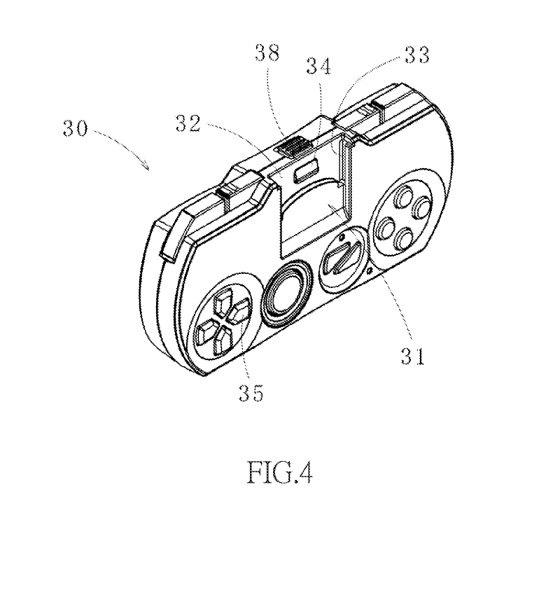

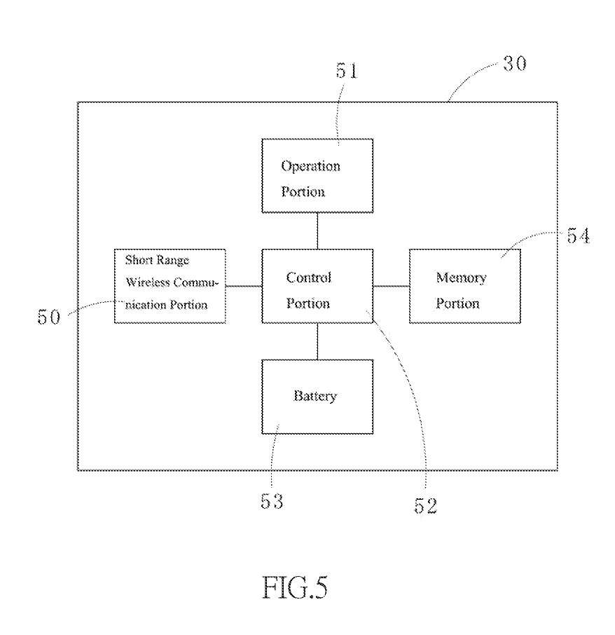

Also, at the side of one long edge of portable information terminal controller (30) a USB terminal (37) is installed for charging the embedded battery (53) of portable information terminal controller (see FIG. 5), and on the side surface of one short side of portable information terminal controller (30) is installed with power switch (36). The mounting portion (31) is formed on the segment difference portion (32) lower in height than other portion of surface of the device controller (30) and the other long side of the device controller (30) is used as the insert port (32a) of the device holder (10). Also, at the center of segment difference portion (32) is set with locking button 34 and can be inserted into the opening (12b) set to lower branch arm (12). At the side surface of the other long side of the device controller (30) a slide button (38) of operable locking button (34) is set (see FIG. 4). Locking button (34) is in shape of wedge and is inclined to the one lower side of insert port (32a) to facilitate the insertion of the device holder.

FIG. 5 is the block diagram of the device controller (30).

The device controller (30) is consisted of operation portion (51) and is comprised of multiple operation key for operating the said device; short range wireless communication portion (50) to be communicated with the said device; memory portion (54) for recording data including control program, control portion (52) for controlling all the portions mentioned above and battery portion (53) as power supply for the above.

Short range wireless communication portion (50) is a communication modular integrally formed with antenna and through short range wireless communication device, such as Bluetooth™ it can have communication process with the device.

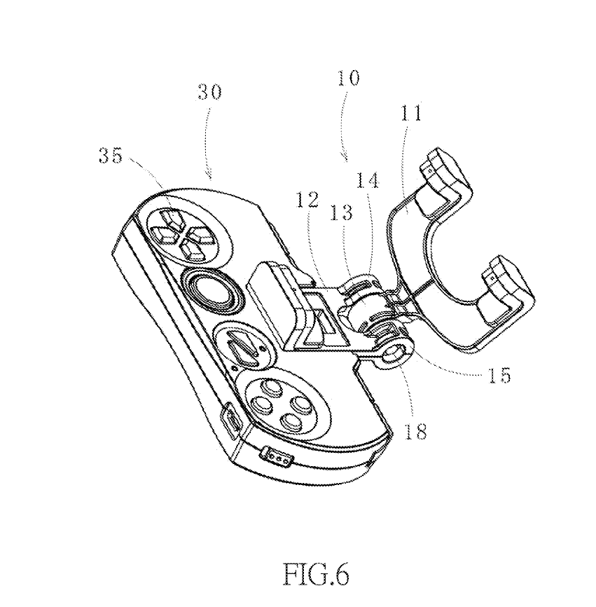

When installing the said device holder (10) onto the device controller (30) the installation portion (19), or the protrude strip portion of the device holder (10), is sliding into the insert port (32a) of groove (33) formed with the mounting portion (31) of the device controller (30) to allow it to slide along with groove (33) (see FIG. 6). By this, the locking button (34) of the device controller (30) is fitted into the opening (12b) of the device holder (10) and made it fixed and cannot be detached from the device controller (30).

On the other hand, when the device holder (10) is to be removed from the said device controller (30), the slide button (38) of the device controller (30) shall be moved to allow locking button (34) to sink into the device controller (30) and allow the said device holder (10) slide to the side of insert port (32a) of mounting portion (31) of the device controller (30).

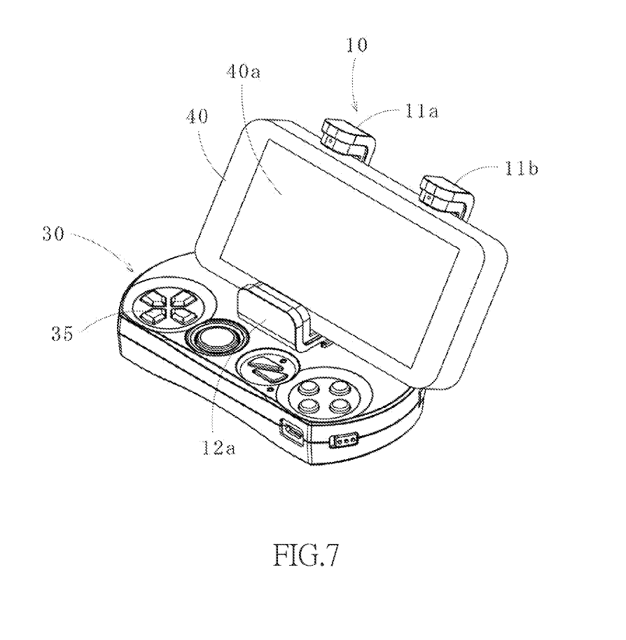

FIG. 7 shows the use status of the device controller (30) that installed with the said device holder (10). With clamping portions (11a & 11 b) of upper branch arm 11 and the clamping portion (12a) of lower branch arm and holding intelligent mobile phone or other type of the said device (40), by operating the operating key (35) of the said device controller (30), and operate the game or other application program performed in the display (40a) of the said device (40) through short range wireless communication.

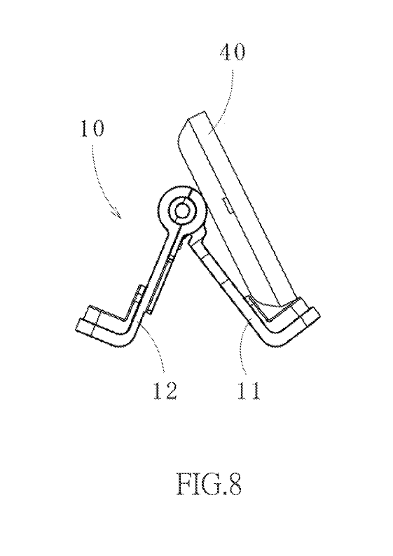

FIG. 8 shows another example of use of the said device holder (10). In this example, the device holder (10) is not mounted on the device controller (30), but lock the upper branch arm (11) and lower branch arm (12) at specific open/close angle and use the device holder (10) as bracket of the device (40) and use the device controller (30) to operate the device (40) at a remote location.

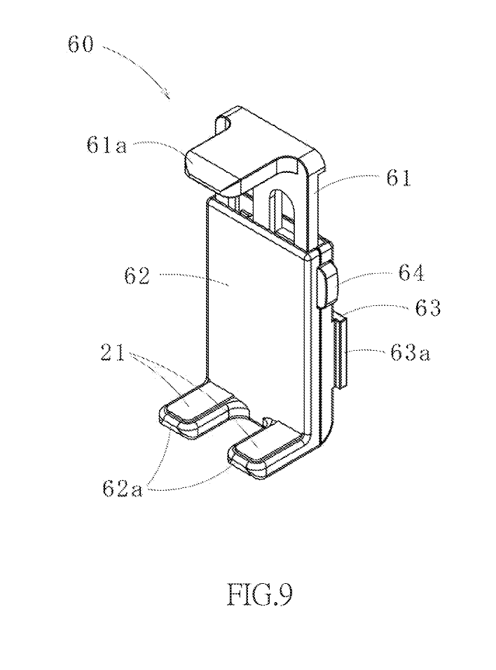

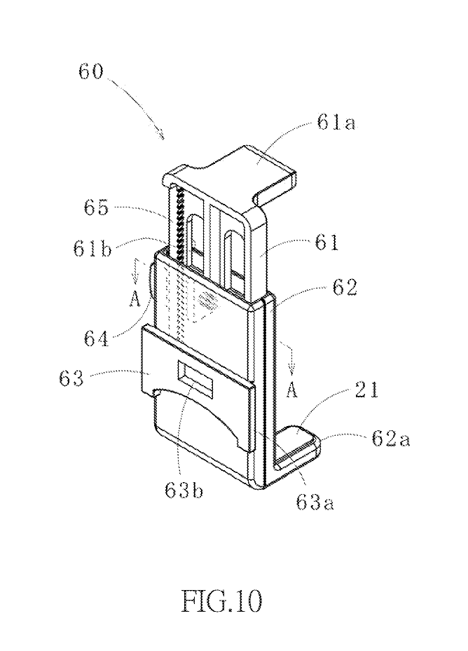

The device holder (60) in 2^{nd} implementation of the present invention is shown in FIG. 9 and FIG. 10. Further, the following explanation is based on upper branch arm (61) and lower branch arm (62) erected, as shown in FIG. 9 and FIG. 10.

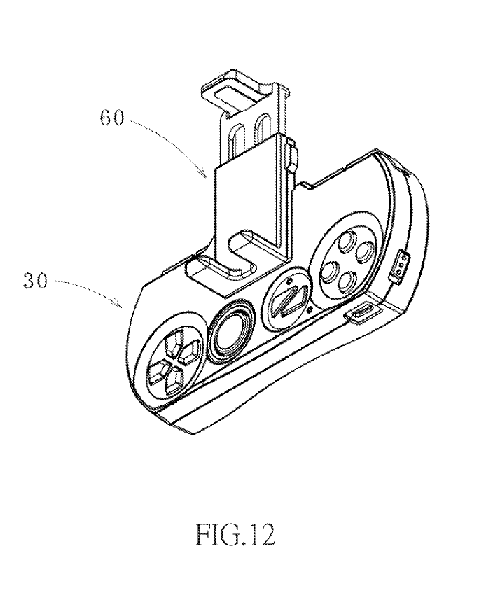

The device holder (60) comprises one pair of branch arms which are the upper branch arm (61) and the lower branch arm (62) to support and the installation portion (63) that can have the controller (30) to install and remove the said device freely (see FIG. 12).

Upper branch arm (61) is formed with board mass roughly in shape of rectangular. The front end part (the upper end portion) is to be used as clamping portion (61a) for clamping the said device and in side-view is bent into I shape. Also, the board mass of upper branch arm 61, without obstructing the press button (64) as described below, form a long hole (61b) extending to the long side direction of upper branch arm 61.

On the other hand, the lower branch arm (62) is formed a thin and flat box form with opening at the top side, and the upper branch arm (61) is inserted into the box. the lower branch arm (62) split two front end portion (lower end portion) is used as the clamping portion (62a) for holding the device, and when it is looked from side, it is in I shape.

Further, elastomer made of rubber or similar property material is adhered to the clamping portion (61a) of upper branch arm (61) and clamping portion (62a) of lower branch arm that contact with the said device.

On the long side of upper branch arm (61) formed a 3^{rd} geared portion (65) (see FIG. 10). The gears of 3^{rd} geared portion (65) are in the shape of triangle and are comprised of a horizontal surface and oblique surface drawing from the top edge of the horizontal surface.

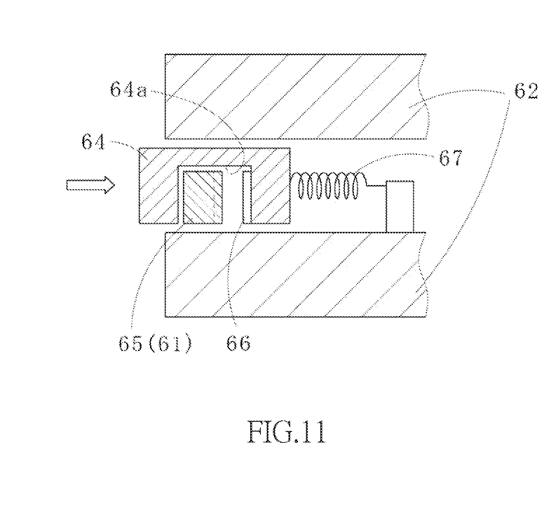

On the other hand, set press button (64) at long edge side of lower branch arm (62) and form 4^{th} geared portion (66) to be engaged with the 3^{rd} geared portion (65). The press button (64) is shown in FIG. 11, and it is with a lay-flatUshape of dented (64a). The 3^{rd} geared portion (65) is inserted through the dented portion (64a), and the 4^{th} geared portion (66) is formed on the wall of dented portion (64a). Also, the press button (64) is connected with the lower branch arm (62) with oil spring (67) and press button (64) is sustaining the downward branch arm (62) long edge lateral pressure.

When the press button (64) is pressed, the 4^{th} geared portion (66) formed together with press button (64), will be moving along with long edge of lower branch arm (62), and the engagement of 3^{rd} geared portion (65) and 4^{th} geared portion (66) will be released. With this, it can cause the upper branch arm 61 to slide upward with lower branch arm (62) (expanding the spacing between the clamping portion (61a) of upper branch arm (61) and clamping portion (62a) of lower branch arm (62).

Further, when causing upper branch arm (61) to slide downward with lower branch arm (62) (diminishing the spacing between the clamping portion (61a) of upper branch arm and clamping portion 62a of lower branch arm (62), there is no need to press down press button (64).

If release from press button 64, the 4^{th} geared portion (66) formed together with press button (64), subject to the lateral pressure of coil spring (67) will be moving to long edge side of lower branch arm (62), and 3^{rd} geared portion (65) and 4^{th} geared portion (66) will be engaged, and in this way, the upper branch arm (61) will not be able to slide to the lower branch arm (62).

The installation portion (63) for freely installing and removing to portable information terminal controller (30) is formed at the back side of lower branch arm (62), and the two sides of installation portion (63) are formed to convex strip (63a) and extended from two edges at the long edge direction of lower branch arm (62), also, at the middle part of installation portion (63) an opening (63b) for inserting the locking knob (34) (See FIG. 3) of portable information terminal controller (30).

FIG. 12 indicates the portable information terminal controller (30) after installing portable information terminal holder (60). The method of installing portable information terminal (60) to portable information terminal controller (30) and the method of removing portable information terminal holder (60) from portable information terminal controller (30) are same as the situation with portable information terminal holder (10).

The above explained the implementation forms of the present invention, however, the present invention is not limited to any above implementation forms, but also include other imaginable implementation forms within the scope as stated in the scope of patent applied, or the modified types. For example, in the Implementation Form 1, it may be that the inner peripheral surface of shaft branch portion of lower branch arm is set with geared portion and the shaft branch portion of upper branch arm is set with caved portion, or the other way around. Also, in the implementation forms 1 & 2, the installation portion of the device holder is set to be protruded strip and the mounting portion is changed to be groove, or the installation portion of the holder changed to be groove and the mounting portion to of the controller is changed to be protruded strip.

### INDUSTRIAL APPLICABILITY

The portable information terminal device holder and the portable termination terminal device controller for mounting the portable information terminal device supporter of this invention can be used as the operating apparatus of portable information terminal device with short range wireless communication functions.

### REFERENCE SIGNS LIST

10 , 60: Portable Information Terminal Device Holder
11 , 61: Upper Branch Arm
12 , 62: Lower Branch Arm
11a, 11b , 12a , 61a, 62a: Clamping Portion
12b, 63b: Opening Portion
13 , 14 , 15: Shaft Support Portion
14a: Geared Portion
15a, 15b Semi, Cylinder
16: Cylindrical Element
16a: 1^{st} Geared Portion
16b: Protruded Portion
17 , 67: Coil Spring
18: Branch Shaft
18a: Diameter Expansion Portion
19 , 63: Installation Portion
20 , 64: Press Button
21: Elastomer
22: Key
30: Portable Information Terminal Device Controller
31: Mounting Portion
32: Segment Difference Portion
32a: Insert Port
33: Groove
34: Locking Button
35: Operation Key
36: Power Switch
37: USB Terminal
38: Slid Button
40: Portable Information Terminal Device
40a: Display
50: Short Range Wireless Communication Portion
51: Operation Portion
52: Control Portion
53: Battery
54: Memories
61b: Long Hole
63a: Extrude Portion
64a: Caved Portion
65: 3^{rd} Geared Portion
66: 4^{th} Geared Portion

1. A holder of portable information terminal device for holding portable information terminal device with short range wireless communication function and is featured with:
one pair of Supporting Arms and the front end is used to hold the portable information terminal device;
a mounting portion, used to mount on the portable information terminal device controller that operates the portable information terminal in a manner that can mount and remove freely;
one pair of the supporting arms with the clearance of the front end is set to adjustable.

2. The holder of portable information terminal device as described in claim 1, featured with a pair of the supporting arm using the supporting axis as fulcrum and making itself a mechanism for open and close and at each base end of said supporting arm pair axially supported the supporting axis, cylindrical elements are set to around it; the cylindrical elements are connected to the base end of the said supporting arm and said supporting arm is rotating along with the supporting axis, and it can move along with the supporting axis, and with the first geared portion formed with the cylindrical element and the 2^{nd} geared portion formed with the other supporting arm and the base end portion and locked a pair of the said supporting arm open/close angle and by separating the first and second geared portion, the locking is released.

3. The holder of portable information terminal device as described in claim 1, featured in that one pair of said support arm, setting it a mechanism with one of said supporting arm can slide toward the other supporting arm, and through the 3^{rd} geared portion for with the other branch arm extending toward the sliding direction to engage with the 4^{th} geared portion formed with one said supporting arm in movable manner to lock the other supporting arm's slide to the other supporting arm, and with the separation of the 3^{rd} and 4^{th} geared portion, the locking is released.

4. The holder of portable information terminal device as described in claim 1, the portable information terminal device is featured with the side-engagement mounting portion.

5. A type of portable information terminal device controller for operating short range wireless communication function portable information terminal devices with the characteristics of the mounting portion can mount the portable information terminal device supporting gear as described in claims 1 through 4, in a free mounting and removing manner, and operation portion used to operate the portable information terminal device and short range wireless communication portion to communicate with said portable information terminal device.

6. The portable information terminal device controller as described in as described in claim 5, the portable information terminal device controller is featured with that the Mounting Portion is in slide engagement.
